(19) United States
(12) Patent Application Publication
(10) Pub. No.: US 2003/0068533 A1
(43) Pub. Date: Apr. 10, 2003

(54) Systems for the conversion of water into non-oxidizing gases and electronic devices containing said systems

(75) Inventors: Luca Toia, Carnago (IT); Lorena Cattaneo, Busto Arsizio (IT)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: SAES GETTERS S.p.A.

(21) Appl. No.: 10/301,355

(22) Filed: Nov. 21, 2002

Related U.S. Application Data
(63) Continuation-in-part of application No. PCT/IT02/00019, filed on Jan. 15, 2002.

(30) Foreign Application Priority Data
Jan. 16, 2001 (IT) MI2001A 000068

(51) Int. Cl. B32B 9/00

(52) U.S. Cl. 428/698

(57) ABSTRACT

Systems capable of converting water into reducing gases are described. These systems can be employed in moisture sensitive electronic and microelectronic devices, whose functioning is not influenced by the contact with reducing gases; in particular, the systems according to the invention can be used in the screens, known as OLEDs, containing electroluminescent organic materials.

The present invention relates to systems for the conversion of water into non-oxidizing gases and to electronic devices containing them, in particular screens containing electroluminescent organic materials.

It is known that the functionality of certain electronic devices can be impaired by contact with water, even if present in traces. It is the case, for example, of the semiconductor devices, wherein water may oxidize the electric contacts or chemically alter some parts; or of the laser amplifiers used in the optical fiber communications, as described in patent application EP-A-720260.

An electronic application of high industrial interest wherein the presence of water must be avoided are the electroluminescent screens based on the use of organic materials, known on the field as OLEDs (Organic Light Emitting Devices).

In brief, the structure of an OLED is formed of a first, essentially planar, transparent support generally made of glass or of a plastic polymer; a first series of transparent electrodes (generally having anodic functionality), which are linear and parallel to each other, deposited on the first support; a double layer of different electroluminescent organic materials, of which the first is conductor of electrons and the second of electronic vacancies (also said “holes”), deposited on the first series of electrodes; a second series of electrodes (generally having cathodic functionality) linear and parallel to each other and having orthogonal orientation with respect to those of the first series, in contact with the upper portion of the double layer of organic materials, so that this latter is comprised between the two series of electrodes; and a second support not necessarily transparent, which may be of glass, metal or plastic, essentially planar and parallel to the first support. The two supports are fixed to each other along their perimeter, generally by gluing, so that the active part of the structure (electrodes and electroluminescent organic materials) is in a close space. The first transparent support is the part wherein the image is visualized, whereas the second support has generally only the function of closing and supporting the device, in order to provide the same with sufficient mechanical strength. The anode is formed of a transparent conducting material, generally the semiconducting mixed oxide of indium and tin, known in the field with the abbreviation ITO, whereas the cathode is formed of alkali-earth metals, like Ba, Ca, and alloys Mg—Ag and Al—Li. When a difference of potential is applied to the electrodes, electrons and holes are conveyed to the double layer of organic materials and combine, leading to the production of photons, whose wavelength depends on the nature of the organic material used.

For an exposition of the principles of the functioning of OLEDs and for greater details on their structure, the wide literature of the field is referred to.

A problem which has been found in the OLEDs functioning is their degradation upon exposure to moisture, which may react with the organic materials (generally polyunsaturated and therefore rather reactive species), as well as with the cathode, formed of particularly reactive metals. The zones interested by these reactions loose their functionality of light emission, thus appearing like black spots on the screen.

In order to overcome this problem, international publication WO 99/03122 describes the introduction into the internal space of an OLED of a gas reactive towards water, for example selected among silanes, trimethylaluminum or triethylaluminum. These gases react quickly with the water molecules by subtracting them to the internal space of the OLED and generating reaction products which are not harmful for the device working. However, the introduction of a gas into an OLED during the manufacture thereof is difficult to carry out.

Other patent publications describe the use inside the OLEDs of moisture sorbing materials.

International publication WO 98/59356 describes the use of a getter material positioned inside the OLED and fixed to the second support. This document generally indicates the possibility of using materials such as Ba, Li, Ca, BaO or the like; among these, the metals Ba, Li and Ca are particularly reactive, besides than water, with other atmospheric gases, so that the handling thereof in an industrial process is particularly difficult. The cited document does not explain how to integrate the introduction of these materials with the manufacturing process of the OLED. Barium oxide, BaO, can be used in the industry in a simpler way, but it is a toxic compound whose use is not appreciated in the industry.

Also U.S. Pat. No. 5,804,917 and international publication WO 99/35681 indicate the possibility of employing moisture sorbing materials, but they do not solve the deficiencies above mentioned for the publication WO 98/59356, describing the use of these materials in an extremely vague way, without specifying the nature of the sorbing materials nor giving any details on a possible manufacturing process of OLED screens containing said materials.

U.S. Pat. No. 5,882,761 describes the use of solid materials which chemically fix water remaining in the solid state, such as for example calcium oxide (CaO). A possible problem in the use of sorbers of this kind is the fact that these materials are generally in the form of a powder, and therefore require to be held by a sheet (for example, non-woven tissue) which is permeable to water but capable of retaining powder particles. The use of powder material and of the permeable sheet prevents the minimum thickness of the component intended for water sorption from getting below threshold values of about 0.3-0.4 mm; on the other hand OLED manufacturers, in order to exploit at best the potentialities of these flat and thin screens, require moisture sorbing systems with thickness values lower than the above indicated ones. Another problem that prevents the reduction of thickness of the sorbing systems based on the use of CaO or similar is the reduction of the water sorbing capacity.

Object of the present invention is providing systems for water removal to be used in water-sensitive electronic devices, in particular screens containing electroluminescent organic materials. In particular, object of the invention is providing moisture removal systems, whose manufacture and introduction inside the final electronic device can be easily integrated in the manufacturing process of the latter, and which are characterized by a high capacity of water removal so that systems of water removal having a lower thickness with respect to the present ones can be obtained.

This object is obtained according to the present invention by means of moisture converting systems, based on the use of materials which are capable of reacting with water forming a gas, which is not harmful for the electronic device wherein said systems are employed.

Examples of materials which is possible to employ in the systems according to the invention are aluminum carbide, Al₄C₃, the aluminum-magnesium compound Al₃Mg₂, and barium nitride, Ba₃N₂. These compounds react with water respectively according to the following reactions:

Al₄C₃+12H₂O→4Al(OH)₃+3CH₄ (I)

Al₃Mg₂+13H₂O→3Al(OH)₃+2Mg(OH)₂+(13/2)H₂ (II)

Ba₃N₂+30H₂O→3Ba(OH)₂.8H₂O+2NH₃ (III)

The sorption capacity, C, of a gas sorbing materials is indicated generally in the field as:

C=(P×V)/Q

wherein: P=pressure at which sorption takes place measured in millibars (mbar), V=volume of sorbed gas measured in liters (l), and Q=quantity of sorbing material used, measured in grams (g).

The materials according to the known art, besides having the problem that they must be used in powder and held by suitable water-permeable sheets, have a theoretical water sorbing capacity (Cₜ) between 150 and 650 (mbar×1/g); the value of Cₜ for CaO is about 435 (mbar×1/g). On the contrary, the materials according to the invention have a theoretical capacity (in this case, a capacity of water conversion) of about 2060 (mbar×1/g) in the case of Al₄C₃, of about 2480 (mbar×1/g) in the case of Al₃Mg₂, and of about 1267 (mbar×1/g) in the case of Ba₃N₂.

As an example of the water removal capabilities of a system of the invention, it can be considered an OLED screen having an internal space of volume of 0.1 cm³ into which, during the life of the device, about 10 mbars of water get in: in these conditions, in order to make sure that all the water is removed (by sorption or transformation into non harmful species) about 2.3×10⁻³ mg of CaO, 4.9×10⁻⁴ mg of Al₄C₃, 4×10⁻⁴ mg of Al₃Mg₂ and 7.9×10⁻⁴ mg of Ba₃N₂ will be necessary. It is therefore evident that, with equal quantity of water to be removed, the quantity of active material to be employed in the case of the invention is about one order of magnitude lower with respect to the materials of the known art.

Besides, some of the materials known in the art (such as for example CaO and BaO) must be used in greater quantities than the stoichiometric ones. This is because, upon water sorption, a crust tends to form on the surface of these oxides which makes difficult the subsequent contact between water and the inside of the sorbing material so that, in order to ensure the necessary sorption features, quantities of oxides of the order of tens of milligrams need to be used.

Another advantage of the converter materials of the invention is that they may be used in the form of thin layers deposited with the typical techniques of the microelectronic industry, such as evaporation, cathodic deposition (better known with the term “sputtering”) or the techniques of chemical deposition from vapor phase (commonly known as CVD, from “Chemical Vapor Deposition”). By operating according to one of these techniques, it is possible to deposit a thin layer of a material according to the invention directly on a surface already present in the electronic device (for example, on the internal part of the second support in the case of the OLEDs) in a process step integrated among the various manufacturing steps of the complete device.

The materials according to the known art present difficulties if they have to be deposited with these techniques: the alkali or alkali-earth metals, as said, are extremely sensible to various atmospheric gases and their use in any manufacture is difficult (as well as their production and storing), whereas the materials of the invention are much less reactive towards all gases which may be present in the atmosphere of the manufacturing plants, apart from water. As to the oxides such as CaO and BaO, they are not suitable for being deposited in a single passage with one of the above cited techniques.

Besides, the high capacity of water conversion of the materials according to the invention also offers the further advantage that the systems which employ them can have very thin thickness values, for example of the order of 0.1 mm, which cannot be obtained with the presently used sorbing systems based on CaO powders held by a water permeable sheet, which as said in the foregoing cannot be produced with thickness values lower than about 0.3-0.4 mm.

Even if the description of the systems according to the invention has been made with particular reference to their use in the OLED screens, it will appear to those skilled in the art that these systems can find application, offering the same advantages, also in other microelectronic devices which are sensible to the action of moisture.

1. Moisture converting system comprising a material capable of reacting with water by forming a reducing gas.

2. System according to claim 1 wherein said material is aluminum carbide.

3. System according to claim 1 wherein said material is the compound Al₃Mg₂.

4. System according to claim 1 wherein said material is barium nitride.

5. System according to claim 1 wherein said material is in the form of thin layer deposited on a substrate by a technique selected among evaporation, cathodic deposition and Chemical Vapor Deposition.

6. Moisture sensitive electronic device comprising a water converting system according to one of the preceding claims.

7. Electronic device according to claim 6 consisting in a screen formed of a first transparent support and of a second support not necessarily transparent fixed to the first support along the perimeter, between which are comprised two mutually perpendicular series of electrodes and, between said series of electrodes, a double layer of electroluminescent organic materials.

8. Electronic device according to claim 7 wherein the screen contains a system of claim 1 in the form of a layer of a water converting material having a thickness lower than 0.2 mm deposited on the internal portion of the second support of the screen by means of cathodic deposition.
